(19) United States
(12) Patent Application Publication
(10) Pub. No.: US 2010/0270521 A1
(43) Pub. Date: Oct. 28, 2010

(54) CARRIER DEVICE FOR A HOSE PACKET OF SUPPLY LINES OF AN OPERATING ROBOT

(75) Inventors: Kaus-Dieter Hock, Homburg (DE); Dominick Winter, Nunkirchen (DE); Gunter Reineke, Weyhe (DE)

Correspondence Address: PROSKAUER ROSE LLP, ONE INTERNATIONAL PLACE, BOSTON, MA, 02110, US

(73) Assignee: THYSSENKRUPP DRAUZ NOTHELFER GMBH, Heilbronn (DE)

(21) Appl. No.: 11/624,078

(22) Filed: Jan. 17, 2007

(30) Foreign Application Priority Data
Jan. 19, 2006 (DE) 102006002637.3-15

(51) Int. Cl. B66F 11/00

(52) U.S. Cl. 254/264; 254/387; 901/50

(57) ABSTRACT

The invention relates to a carrier device for a hose packet 5 of supply lines of a working robot. The hose packet 5 is secured by the intermediary of a compensator 6 to a carrier element 7, which can be lowered from a high operating position above the working robot 4 into a lower maintenance position at floor level by way of traction means. Thanks to the compensator 6, in the operating position the hose packet is on the one hand held high, but, on the other hand, can also give when force is applied.

The invention relates to a carrier device for a hose packet of supply lines of a working robot having an operating head, wherein the hose packet is suspended above the working robot on the one hand on a carrier formed from a transverse element and with the formation of a loop, and, on the other hand, on a compensator retained on the carrier by means of retaining means, wherein the compensator can give in relation to the supply lines connected to the operating head when traction is applied to them.

A working robot, when operating on an object such as the bodywork of a motor vehicle, carries out in part very complex and rapid movements with its operating head, during which the supply lines, such as fibre optic cables for laser beam welding, laser beam soldering, or laser beam cutting heads, signal lines, electric cables, and water and process gas hoses, are subjected to substantial traction and torsion loads. These loads make it necessary for the hose packet to be replaced after a relatively short operating period as part of a programme of preventive maintenance.

With conventional carrier devices for a hose packet of supply lines of the type referred to in the preamble, provision is made for the supply lines connected to the operating head to be carried by a compensator, which is located either on the ceiling of an operating cabin in which the working robot is installed, or connected to a cantilever arm projecting into the operating cabin. Such an arrangement has the advantage that the supply lines come from above and are held up in a working position which is set high as well as low, so that they do not lie in the way causing an obstacle during operation. A disadvantage with this type of carrier device, however, is that for maintenance work the maintenance personnel must be conveyed by means of ladder or lifting equipment to the high locations of the carrier and the compensator, or the personnel access platforms in the operating cabin must be securely installed with railings and stair accessways at the height of the carrier and the compensator. These precautionary measures for maintenance work are elaborate and expensive both with regard to the time required for maintenance as well as with regard to the costs for the installation of the platforms and the like.

These problems with maintenance work are not addressed by a known carrier device of the type referred to in the preamble (DE 87 03 229 U1). With this carrier device, the carrier is carried as a cantilever arm on a column. Whether the column allows for a pivoting or lowering of the cantilever arm is not represented and not described in this prior art. However, even if the column were capable of being lowered, the control box which is attached to the column would mean that it could only be lowered to what is still a relatively high level. In any event, such a means of holding the carrier, designed as a cantilever, to a column is an elaborate and complicated arrangement.

The invention is based on the object of providing a carrier device which allows for maintenance work to be carried out on the hose packet of the working robot with comparatively low expenditure and effort.

This object is resolved with a carrier device of the type referred to in the preamble, in that the carrier is suspended on traction means, and can be lowered by these traction means out of a high operating position secured to fixed-location guide stops into a lower maintenance position at floor level.

With the carrier device according to the invention, maintenance work can be carried out rapidly, safely, and with minimal expenditure and effort in terms of device technology. On the one hand, the carrier suspended on traction means and fixed to guide stops guarantees a defined position for the compensator above the working robot, and, on the other hand, guarantees easy access to the hose packet from floor level. The effort and expenditure in terms of device technology is low in comparison with working platforms and the like, because only guide stops and traction means are required for the fixing and easy access.

In order to facilitate the fixing of the carrier to the guide stops, one embodiment of the invention makes provision for these to be designed in the shape of a fork, wherein the fork prongs are matched to the width of the carrier, designed as a transverse element.

The traction means preferably take the form of a traction cable, which runs over deflection rollers to a cable winch at floor level.

In order to keep the entire working area free of supply lines, the carrier should extend as far as the side wall of the cabin in which the working robot is installed, and the hoses, lines and/or cables leading from the hose packet to their supply units should be guided along the length of the cabin wall.

The invention is explained in greater detail hereinafter on the basis of a drawing, which shows a diagrammatic representation of a cabin with a working robot.

Specifically, this shows:

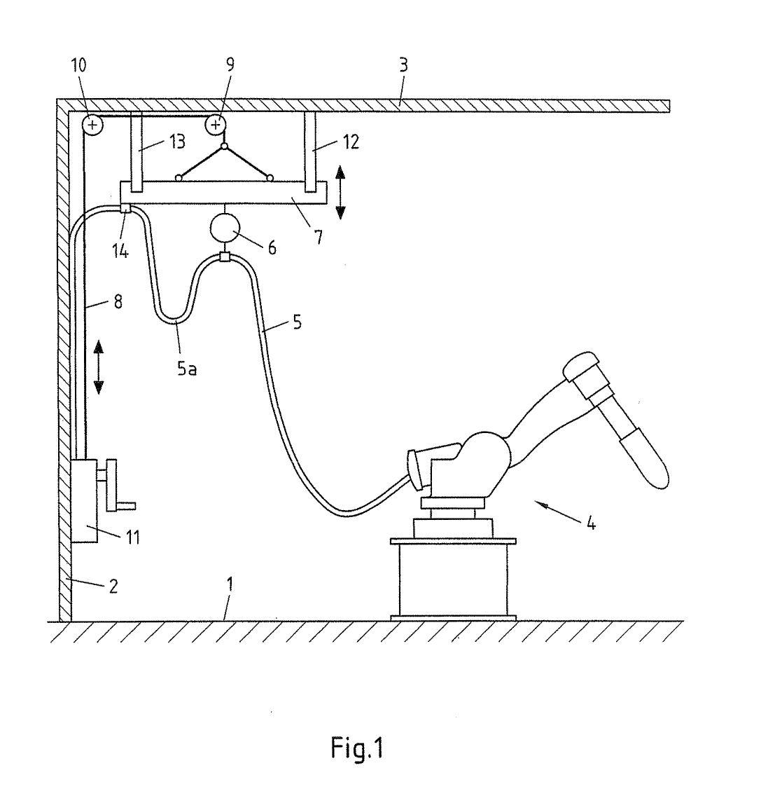

FIG. 1 A cabin with working robot and carrier device for a hose packet carried by a carrier, in the operating position in vertical section, and

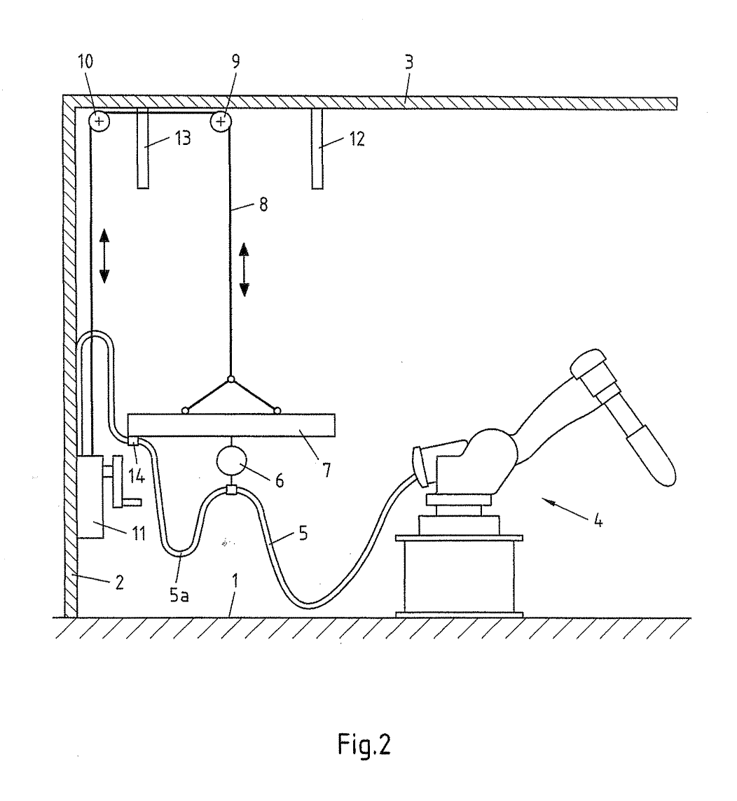

FIG. 2 The cabin according to FIG. 1, with the hose packet carried by the carrier, in the maintenance position, in vertical section.

In an operating cabin with floor 1, side wall 2, and ceiling 3, a working robot 4 with an operating head 4a is installed. The working robot 4 is designed for very complex movements of its operating head 4a, so that it can reach the most widely differing positions on a workpiece, not shown, such as the body of a motor vehicle, and can carry out the work required there. A typical type of operation of the operating head is laser beam welding.

In order for the operating head 4a to carry out the necessary work, it is supplied from supply units, not shown, via a hose packet 5. The hose packet 5 can comprise fibre optic cables for laser beams, signal lines, electric cables, or water and process gas hoses. One particular feature of the hose packet 5 consists of the fact that the hose packet section connected to the operating head does not come from the side but from above, so that the working area of the working robot, where the workpiece to be dealt with is located, in particular a motor vehicle body, is free of obstructing hoses.

The hose packet 5 is secured by means of a compensator 6 to a carrier 7, designed as a transverse element. The carrier 7 is suspended from traction means 8, which are designed as a traction cable, and run via deflection rollers 9, 10, secured to the ceiling 3, to a cable winch 11 at floor level. By means of these traction means 8, the carrier 7 is drawn against guide stops 12, 13, secured in a fixed position to the ceiling 3, these stops being designed in the shape of a fork in order to be able to accommodate the carrier 7 designed as a transverse element in positive fit on both opposing sides. In this manner the carrier 7 can be precisely positioned spatially.

The hose packet 5 is secured on the one hand by retaining means 14 to the carrier 7, and, on the other hand, is held by the compensator 6, forming a loop 5a. The compensator 6 allows for the arrangement that, when traction is exerted on the supply lines by the operating head 4a, it can give in relation to the lines. This can be achieved in various ways. Either the hose packet 5 is fixed to the compensator 6, and the compensator 6 is suspended in a spring-loaded manner to the carrier or the compensator 6 is fixed to the carrier and holds the hose packet 5 by means of a spring tensioning device. In both cases, it is possible, by exploitation of the loop 5a, on the one hand to hold the hose packet 5 high up, and, on the other hand, to give in terms of length, depending on whether the operating head requires this or not as a function of its operational movements.

Because the carrier 7, designed as a transverse element, reaches from the middle of the cabin as far as close to the side wall 2, it is guaranteed that the section of the hose packet 5 which runs to the supply units, not shown, does not lie in the working area and create an obstacle, but runs essentially along the length of the side wall 2.

As FIG. 2 shows, with the carrier 7 in the lowered maintenance position, the hose packet 5 can be reached from floor level by the service personnel at the points at which it needs to be replaced, so that the work of replacement can be carried out safely and rapidly.

1. Carrier device for a hose packet (5) of supply lines of a working robot (4) having an operating head (4a), wherein the hose packet (5) is suspended above the working robot (4) on the one hand on a carrier (7) formed from a transverse element and with the formation of a loop (5a), and, on the other hand, on a compensator (6) retained on the carrier (7) by means of retaining means, wherein the compensator (7) can give in relation to the supply lines connected to the operating head (4a) when traction is applied to them, wherein the carrier (7) is suspended on traction means (8) and can be lowered by these traction means (8) out of a high operating position secured to fixed-location guide stops (12, 13) into a lower maintenance position at floor level.

2. Carrier device according to claim 1, wherein the guide stops (12, 13) are designed in the shape of a fork, the prongs of which are matched to the width of the carrier (7) designed as a transverse element.

3. Carrier device according to claim 1, wherein the traction means (8) take the form of a traction cable, which runs over deflection rollers (9 , 10) to a cable winch (11) at floor level.

4. Carrier device according to claim 1, wherein the carrier (7) designed as a transverse element extends as far as the side wall (2) of the cabin in which the working robot (4) is installed, and the hoses, lines and/or cables leading from the hose packet (5) to their supply units, are guided along the length of the cabin wall (2).
